(19) United States
(12) Patent Application Publication
(10) Pub. No.: US 2004/0208086 A1
(43) Pub. Date: Oct. 21, 2004

(54) HOURGLASS

(76) Inventor: Frank Lee, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/249,558

(22) Filed: Apr. 18, 2003

(51) Int. Cl. G04F 1/04

(52) U.S. Cl. 368/93

(57) ABSTRACT

An hourglass package includes an hourglass having two ends. An elastic structure is mounted on the two sides of the hourglass, respectively, wherein the elastic structure has a first part at an end surface of the hourglass and second part along a side outer peripheral surface of the hourglass. An outer case is used to adapt the hourglass with the elastic structure.

### BACKGROUND OF INVENTION

1. Field of Invention

The present invention relates to an hourglass. More particularly, the present invention relates to an hourglass toy with protection structure for preventing from being broken.

2. Description of Related Art

The hourglass has been well known in the world. The hourglass is first designed to count the time in the early stage. After the clock was introduced, the hourglass is gradually replaced by the clock. Nowadays, the hourglass is rather used as a decoration or a simple toy.

As a toy, the hourglass plays its interesting role in the toy market due to its particular mechanism, which produces a lot of fun. The conventional hourglass toy is shown in FIG. 1. In FIG. 1, the hourglass toy 100 has a sealed glass 102 has two parts. The two parts are joint by a neck part 106. Inside the glass 102, some sand or sand-like material 104 is partially filled. As a result, when the hourglass is standing up, the sand-like material 104 at the upper part is gradually dropping into the lower part through the neck part 106. Again, when the hourglass is standing up in reverse direction, the sand-like material goes the reverse direction. The mechanism of the hourglass is well known.

Since the hourglass 102 has the weak mechanical strength at the neck part 106, usually, the hourglass 102 is installed in an outer case 108 as the hourglass toy 100. In order to affix the hourglass 102 to the outer case 108, the hourglass is rigidly affixed to the inner wall of the outer case 108. In this manner, the hourglass toy 100 can be freely played. However, when the hourglass toy 100 is accidentally falling down to the ground, the hourglass 102 may be broken.

In the foregoing consideration, how to effectively prevent the hourglass from being broken is an issue for the manufacturers.

### SUMMARY OF INVENTION

The invention provides a hourglass package, suitable for use as a toy, which has better ability to resist mechanical impulse. Then, the hourglass can be effectively prevented from being broken.

As embodied and broadly described herein, the invention provides an hourglass package. The hourglass package includes an hourglass having two ends. An elastic structure is mounted on the two sides of the hourglass, respectively, wherein the elastic structure has a first part at an end surface of the hourglass and a second part along a side outer peripheral surface of the hourglass. An outer case is used to adapt the hourglass with the elastic structure.

The hourglass package of the invention can at least resist the mechanical impulse when the hourglass package, for example, falls down to the ground.

In the foregoing hourglass package, the second part further comprises a protruding part.

In the foregoing hourglass package, the first part and the second part are an integrated single structure.

In the foregoing hourglass package, the first part and the second part are completely separated.

In the foregoing hourglass package, the first part and the second part of the elastic structure are partially completely separated.

In the foregoing hourglass package, the second part comprises a plurality of portions evenly distributed along the cross-sectional circle of the hourglass body.

The invention also provides an hourglass package. The hourglass package includes an hourglass having two ends. An elastic structure is mounted on the two sides of the hourglass, respectively, wherein the elastic structure disposed at an end surface of the hourglass. An outer case is used to adapt the hourglass with the elastic structure.

The invention also provides an hourglass package. The hourglass package includes an hourglass having two ends. An elastic structure is mounted on the two sides of the hourglass, respectively, wherein the elastic structure is disposed along a side outer peripheral surface of the hourglass. An outer case is used to adapt the hourglass with the elastic structure.

The present invention also provides an hourglass package, which comprises an hourglass body; an outer case enclosing the hourglass body; two elastic structures disposed on two ends of the outer cases, respectively, wherein each of the two elastic structure comprises: a first part located at an end surface of the hourglass body; and a second part located at an outer peripheral surface of the sidewall of the hourglass.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a cross-sectional view, schematically illustrating a conventional hourglass toy.

FIG. 2 is a cross-sectional view, schematically illustrating an hourglass with an elastic structure for resisting the mechanical impulse, according to one preferred embodiment of this invention.

FIG. 3 is a cross-sectional view, schematically illustrating an hourglass package, according to one preferred embodiment of this invention.

FIG. 4 is a cross-sectional view, schematically illustrating an hourglass with an elastic structure for another design, according to one preferred embodiment of this invention.

### DETAILED DESCRIPTION

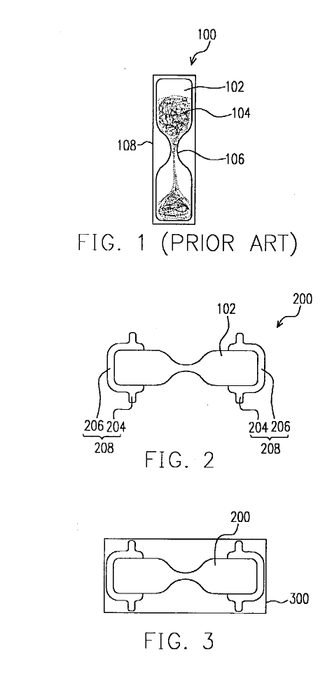

The mechanism for the hourglass has been described in FIG. 1. The invention is directed to the hourglass package, which is suitable for use as a toy. The hourglass package of the invention includes an elastic structure disposed at each end of the hourglass. Due to the elastic effect of the elastic structure, the hourglass can resist the impulse force in both of longitudinal and transversal directions. An embodiment is provided as an example as follows:

FIG. 2 is a cross-sectional view, schematically illustrating an hourglass with an elastic structure for resisting the mechanical impulse, according to one preferred embodiment of this invention. In FIG. 2, the hourglass 102 has two ends. An elastic structure 208 is mounded on each end. The elastic structure 208 includes an end part 206 disposed at the end surface of the hourglass 102. The other part is the peripheral part 204 along the outer peripheral surface of the hourglass 120. The hourglass 102 and the elastic structure 208 form an hourglass package 200.

The elastic structure 208 effectively provides a buffering effect for the mechanical impulse in longitudinal direction and the transversal direction when the hourglass 102 is accidentally, for example, falls to the ground.

In order to further protect the hourglass 102, the hourglass 102 is disposed inside an outer case. FIG. 3 is a cross-sectional view, schematically illustrating an hourglass package, according to one preferred embodiment of this invention. In FIG. 3, the hourglass 102 with the elastic structure 208 of the invention as the hourglass package 200 is packaged into an outer case 300. The elastic structure 208 can prevent the hourglass 102 from being broken, for example, when the hourglass package 200 fall to the ground. The outer case 300 usually can be a hollow cylindrical case 300 to enclose the hourglass package 200.

With the same design principle, the elastic structure 208 can be separated into the end part 206 and the peripheral part with its individual protection effect. In other words, the elastic structure can be only the end part or only the peripheral part 204. However, in these manners, only one direction can be protected.

The elastic structure 208 is used with the hourglass 102 can effectively produce the protection effect without much increasing the fabrication cost. The peripheral part 204 is protruding out from the sidewall of the hourglass 102, so as to have better contact with the outer case 300. The size and material are not specifically limited. For example, the protruding length can be, for example, form 0.5 mm up to a few millimeters. This is depending on the actual size of the hourglass. The material of the elastic structure can be, for example, the rubber. Also and the end part 206 and the peripheral part 204 are not necessary always to be joint. It can be two separated parts. The peripheral part 204 can enclose the peripheral surface. Alternatively, the peripheral part 204 can be several portion evenly distributed along the peripheral surface of the hourglass on the cross-sectional circular line. The peripheral part 204 can also just be a circular structure, like a rubber O ring, along the peripheral surface of the sidewall of the hourglass 102. All these specific designs are within the feature of the peripheral part, so as to protect the hourglass.

Further still, the elastic structure 208 can also be implemented on the two ends of the outer case 300. It then also produces the similar protection effect. However, the elastic structure 208 is then protruding out from the outer case 300.

For the practical design on the elastic structure 208 at the end part 206, in order to have better elastic effect for absorbing the impulse, the end part 206 can be designed to have two rings. In addition, the peripheral part 204 can also be designed to have multiple step structure, such as two steps. This can produce two times of buffering effect.

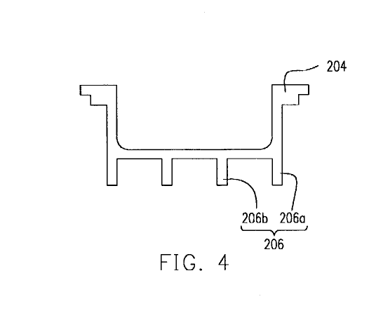

FIG. 4 is a cross sectional view, schematically illustrating an hourglass with an elastic structure for another design, according to one preferred embodiment of this invention. In FIG. 4, the peripheral part 24 in this example has a two-step structure. Furthermore, the end part 206 has the outer protruding ring 206a and the inner protruding ring 206b. However, the number of rings is not limited to two and can be one or more. This is a design choice for the actual design. Likewise, the number of steps for the peripheral part is not limited to be two steps.

In conclusions, the invention introduces the elastic structure 208 disposed on two ends of the hourglass. The hourglass can be protected from braking. Particularly, when the hourglass is used as a toy for a child, the hourglass toy often falls down to the ground. The hourglass can be effectively prevented from being broken. Particularly, the peripheral part 204 can be designed to have at least one step, and the end part 206 can be designed to have at least one ring. Multiple rings and multiple steps can produce more buffering effect to the impulse.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. An hourglass package, comprising:
an hourglass body, having two ends; and
two elastic structures disposed on the two ends, respectively, wherein each of the two elastic structure comprising:
a first part located at an end surface of the hourglass body; and
a second part located at an outer peripheral surface of the sidewall of the hourglass.

2. The hourglass package of claim 1, wherein the first part includes at least one ring structure.

3. The hourglass package of claim 1, wherein the second part further comprises a protruding part, optionally with at least one step structure.

4. The hourglass package of claim 1, wherein the first part and the second part of the elastic structure are an integrated single structure.

5. The hourglass package of claim 1, wherein the first part and the second part of the elastic structure are completely separated.

6. The hourglass package of claim 1, wherein the first part and the second part of the elastic structure are partially completely separated.

7. The hourglass package of claim 1, wherein the second part comprises a plurality of portions evenly distributed along a cross-sectional circle of the hourglass body.

8. The hourglass package of claim 1, wherein the second part is an O-ring like structure along a cross-sectional circle of the hourglass body.

9. The hourglass package of claim 1, wherein the elastic structure includes rubber.

10. A hourglass package, comprising:
an hourglass body, having two ends; and
two elastic structures disposed at the two ends, respectively, wherein each of the two elastic structures is used to reduce a mechanical impulse; and
an outer case, to adapt and affix the hourglass body with the elastic structures.

11. The hourglass package of claim 10, wherein each of the elastic structures is disposed at an end surface of the hourglass body.

12. The hourglass package of claim 10, wherein each of the elastic structures is disposed at an outer peripheral surface of the sidewall of the hourglass body.

13. The hourglass package of claim 12, wherein the electric structure comprises a plurality of portions evenly distributed along the cross-sectional circle of the hourglass body.

14. The hourglass package of claim 12, wherein the electric structure is an O-ring like structure along a cross-sectional circle of the hourglass body.

15. The hourglass package of claim 10, wherein each one of the elastic structures includes at least one ring.

16. An hourglass package, comprising:
an hourglass body;
an outer case enclosing the hourglass body;
two elastic structures disposed on two ends of the outer cases, respectively, wherein each of the two elastic structure comprising:
a first part located at an end surface of the hourglass body; and
a second part located at an outer peripheral surface of the sidewall of the hourglass.

17. The hourglass package of claim 16, wherein the second part further comprises a protruding part, optionally with at least one step structure.

18. The hourglass package of claim 16, wherein the first part and the second part of the elastic structure are an integrated single structure.

19. The hourglass package of claim 16, wherein the first part and the second part of the elastic structure are completely separated.

20. The hourglass package of claim 16, wherein the first part and the second part of the elastic structure are partially completely separated.
